(19) United States
(12) Patent Application Publication
(10) Pub. No.: US 2024/0096286 A1
(43) Pub. Date: Mar. 21, 2024

(54) SCAN DRIVER AND DISPLAY DEVICE INCLUDING THE SAME

(71) Applicant: SAMSUNG DISPLAY CO., LTD., YONGIN-SI (KR)

(72) Inventors: KI NYENG KANG, YONGIN-SI (KR); GUANGHAI JIN, YONGIN-SI (KR); SUNKWANG KIM, YONGIN-SI (KR)

(21) Appl. No.: 18/338,569

(22) Filed: Jun. 21, 2023

(30) Foreign Application Priority Data
Sep. 15, 2022 (KR) 10-2022-0116681

(51) Int. Cl. G09G 3/3266

(52) U.S. Cl. CPC G09G 3/3266; G09G 2300/0426; G09G 2300/0814

(57) ABSTRACT

A method of manufacturing a semiconductor device includes designing a semiconductor device layout using a design rule manual (DRM), in which design rules are recorded, and performing failure evaluation of a failure including at least one gate structure failure of a semiconductor device manufactured using the designed semiconductor device layout. The method further includes updating the DRM by updating the design rules recorded in the DRM, based on a result of the failure evaluation, redesigning the semiconductor device layout using the updated DRM, and manufacturing the semiconductor device using the redesigned semiconductor device layout.

### CROSS-REFERENCE TO RELATED APPLICATION(S)

This application claims priority under 35 USC § 119 to Korean Patent Application No. 10-2022-0116681 filed on Sep. 15, 2022 in the Korean Intellectual Property Office (KIPO), the entire disclosure of which is incorporated by reference herein.

### FIELD

The present disclosure generally relates to display devices. More particularly, embodiments of the present disclosure relate to a scan driver and a display device including the scan driver.

### DISCUSSION

A display device may include pixels displaying an image and a scan driver providing scan signals to the pixels. Each of the pixels may include different types of transistors (e.g., a P-type transistor and an N-type transistor). In order to drive different types of transistors, the display device may include two or more scan drivers. When the display device includes two or more scan drivers, a dead space of the display device may increase.

### SUMMARY

Embodiments provide a display device in which a dead space is reduced, and a scan driver included in the display device.

A scan driver according to embodiments may include a plurality of stages connected to pixel rows. Each of the stages may output a first scan signal including a first pulse, and a second scan signal including a second pulse having a width greater than a width of the first pulse.

In an embodiment, each of the stages may include a scan signal generator which generates the first scan signal and a scan signal converter which generates the second scan signal based on the first scan signal.

In an embodiment, the scan signal converter may be implemented as a NAND gate.

In an embodiment, the stages may include an n^{th} stage and an (n+1)^{th} stage where n is a natural number greater than or equal to 1. The scan signal converter of the n^{th} stage may generate an n^{th} second scan signal based on an n^{th} first scan signal generated from the scan signal generator of the n^{th} stage and an (n+1)^{th} first scan signal generated from the scan signal generator of the (n+1)^{th} stage.

In an embodiment, the scan signal converter of the n^{th} stage may include a first transistor connected between a high voltage line carrying a high voltage and an output node outputting the n^{th} second scan signal, and turned on in response to the n^{th} first scan signal, a second transistor connected between the high voltage line and the output node, and turned on in response to the (n+1)^{th} first scan signal, a third transistor connected between a low voltage line carrying a low voltage and an intermediate node, and turned off in response to the n^{th} first scan signal, and a fourth transistor connected between the intermediate node and the output node, and turned off in response to the (n+1)^{th} first scan signal.

In an embodiment, each of the first transistor and the second transistor may be a P-type transistor. Each of the third transistor and the fourth transistor may be an N-type transistor.

In an embodiment, an (n+1)^{th} second scan signal output from the (n+1)^{th} stage may partially overlap the n^{th} second scan signal output from the n^{th} stage.

In an embodiment, the scan signal generator may include a P-type transistor and an N-type transistor.

In an embodiment, the second scan signal may be obtained based on inverting the first scan signal, and the width of the second pulse may be twice or more than the width of the first pulse.

A display device according to embodiments may include pixel rows each of which includes a plurality of pixels and a scan driver which includes a plurality of stages connected to the pixel rows. Each of the stages may output a first scan signal including a first pulse, and a second scan signal including a second pulse having a width greater than a width of the first pulse.

In an embodiment, each of the stages may include a scan signal generator which generates the first scan signal and a scan signal converter which generates the second scan signal based on the first scan signal.

In an embodiment, the scan signal converter may be implemented as a NAND gate.

In an embodiment, the stages may include an n^{th} stage and an (n+1)^{th} stage where n is a natural number greater than or equal to 1. The scan signal converter of the n^{th} stage may generate an n^{th} second scan signal based on an n^{th} first scan signal generated from the scan signal generator of the n^{th} stage and an (n+1)^{th} first scan signal generated from the scan signal generator of the (n+1)^{th} stage.

In an embodiment, an (n+1)^{th} second scan signal output from the (n+1)^{th} stage may partially overlap the n^{th} second scan signal output from the n^{th} stage.

In an embodiment, the second scan signal may be obtained based on inverting the first scan signal, and the width of the second pulse may be twice or more than the width of the first pulse.

In an embodiment, each of the pixels may include a P-type transistor turned on in response to the first scan signal and an N-type transistor turned on in response to the second signal.

In an embodiment, the display device may further include an emission driver which outputs emission signals to the pixel rows, respectively.

In an embodiment, the pixel rows may include an n^{th} pixel row where n is a natural number greater than or equal to 3. The stages may include an (n−2)^{th} stage outputting an (n−2)^{th} first scan signal and an (n−2)^{th} second scan signal, an (n−1)^{th} stage outputting an (n−1)^{th} first scan signal and an (n−1)^{th} second scan signal, and an n^{th} stage outputting an n^{th} first scan signal and an n^{th} second scan signal. The emission signals may include an n^{th} emission signal. A pixel of the n^{th} pixel row may receive the n^{th} first scan signal, the n^{th} second scan signal, the (n−2)^{th} second scan signal, the n^{th} emission signal, and the (n−1)^{th} first scan signal.

In an embodiment, the pixel of the n^{th} pixel row may include a first transistor connected between a first node and a second node, and turned on in response to a voltage of a third node, a second transistor connected between a data line carrying a data signal and the first node, and turned on in response to the n^{th} first scan signal, a third transistor connected between the second node and the third node, and turned on in response to the n^{th} second scan signal, a fourth transistor connected between an initialization line carrying an initialization voltage and the third node, and turned on in response to the (n−2)^{th} second scan signal, a fifth transistor connected between a first power line carrying a first power voltage and the first node, and turned on in response to the n^{th} emission signal, a sixth transistor connected between the second node and a fourth node, and turned on in response to the n^{th} emission signal, a seventh transistor connected between the initialization line and the fourth node, and turned on in response to the (n−1)^{th} first scan signal, a storage capacitor connected between the first power line and the third node, and a light-emitting diode connected between the fourth node and a second power line carrying a second power voltage.

In an embodiment, each of the first transistor, the second transistor, the fifth transistor, the sixth transistor, and the seventh transistor may be a P-type transistor. Each of the third transistor and the fourth transistor may be an N-type transistor.

In the scan driver and the display device including the scan driver according to the embodiments, each of stages of the scan driver may output a first scan signal for driving a P-type transistor and a second scan signal for driving an N-type transistor, so that an area of the scan driver may be reduced, and a dead space of the display device may be reduced.

### BRIEF DESCRIPTION OF THE DRAWINGS

Illustrative, non-limiting embodiments of the present disclosure will be more clearly understood from the following detailed description when taken in conjunction with the accompanying drawings, in which:

FIG. 1 is a block diagram illustrating a display device according to an embodiment;

FIG. 2 is a circuit diagram illustrating a pixel according to an embodiment;

FIG. 3 is a signal diagram for describing an operation of the pixel in FIG. 2 during one frame period,

FIG. 4 is a block diagram illustrating a scan driver according to an embodiment;

FIG. 5 is a signal diagram illustrating scan signals output from the scan driver in FIG. 4;

FIG. 6 is a block diagram illustrating stages according to an embodiment;

FIG. 7 is a logic diagram illustrating a scan signal converter according to an embodiment;

FIG. 8 is a tabular diagram illustrating inputs and an output of the scan signal converter in FIG. 7;

FIG. 9 is a circuit diagram illustrating a scan signal converter according to an embodiment;

FIG. 10 is a block diagram illustrating an electronic apparatus including a display device according to an embodiment; and

FIG. 11 is a perspective diagram illustrating an example of the electronic apparatus in FIG. 10.

### DETAILED DESCRIPTION

Hereinafter, a scan driver and a display device according to embodiments of the present disclosure will be described in greater detail with reference to the accompanying drawings. The same or similar reference numerals may be used for the same or similar elements in the accompanying drawings.

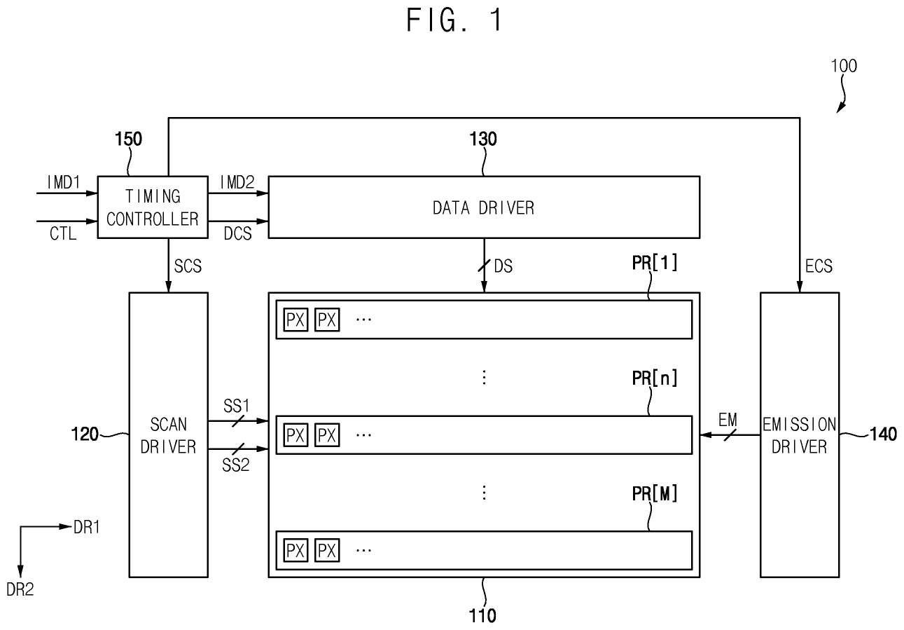

FIG. 1 illustrates a display device 100 according to an embodiment.

Referring to FIG. 1, the display device 100 may include a display unit (or display area) 110, a scan driver (or gate driver) 120, a data driver (or source driver) 130, an emission driver 140, and a timing controller 150.

The display unit 110 may include a plurality of pixels PX. In an embodiment, the plurality of pixels PX may include red pixels emitting red light, green pixels emitting green light, and blue pixels emitting blue light. A plurality of pixel rows PR[1], . . . , PR[n], . . . , PR[M] may be defined by the pixels PX, where n is a natural number greater than or equal to 2, and M is a natural number greater than n and greater than or equal to 3. For example, each of the pixel rows PR[1], . . . , PR[n], . . . , PR[M] may extend in a first direction DR1, and the pixel rows PR[1], . . . , PR[n], . . . , PR[M] may be arranged in a second direction DR2 crossing the first direction DR1.

Each of the pixels PX may include at least one P-type transistor (e.g., a PMOS transistor) and at least one N-type transistor (e.g., an NMOS transistor). In an embodiment, the P-type transistor may include a polycrystalline silicon semiconductor, and the N-type transistor may include an oxide semiconductor.

The scan driver 120 may provide first scan signals SS1 and second scan signals SS2 to the pixels PX. The scan driver 120 may generate the first scan signals SS1 and the second scan signals SS2 based on a second control signal SCS. The second control signal SCS may include a scan start signal, a scan clock signal, or the like.

The first scan signal SS1 may be a scan signal for driving the P-type transistor. In other words, the P-type transistor may be turned on in response to the first scan signal SS1. The second scan signal SS2 may be a scan signal for driving the N-type transistor. In other words, the N-type transistor may be turned on in response to the second scan signal SS2. Accordingly, the P-type transistor of each of the pixels PX may be turned on in response to the first scan signal SS1, and the N-type transistor of each of the pixels PX may be turned on in response to the second scan signal SS2.

The data driver 130 may provide data signals DS to the pixels PX. The data driver 130 may generate the data signals DS based on second image data IMD2 and a third control signal DCS. The second image data IMD2 may include grayscale values corresponding to the pixels PX. The third control signal DCS may include a data start signal, a data clock signal, a load signal, or the like.

The emission driver 140 may provide emission signals EM to the pixels PX. In an embodiment, the emission driver 140 may output the emission signals EM to the pixel rows PR[1], . . . , PR[n], . . . , PR[M], respectively. The emission driver 140 may generate the emission signals EM based on a fourth control signal ECS. The fourth control signal ECS may include an emission start signal, an emission clock signal, or the like.

The timing controller 150 may control an operation of the scan driver 120, an operation of the data driver 130, and an operation of the emission driver 140. The timing controller 150 may generate the second image data IMD2, the second control signal SCS, the third control signal DCS, and the fourth control signal ECS based on first image data IMD1 and a first control signal CTL received from the outside (e.g., a processor). The first image data IMD1 may include grayscale values corresponding to the pixels PX. The first control signal CTL may include a clock signal, a vertical synchronizing signal, a horizontal synchronizing signal, or the like. In an embodiment, the timing controller 150 may generate the second image data IMD2 by compensating the first image data IMD1.

Although FIG. 1 illustrates an embodiment where the scan driver 120 is disposed on a first side of the display unit 110 in the first direction DR1 and the emission driver 140 is disposed on a second side of the display unit 110 in the first direction DR1, the present disclosure is not limited thereto. In an embodiment, the scan driver 120 may be disposed outside the display unit 110 in the first direction DR1 with the display unit 110 disposed therebetween, and the emission driver 140 may be disposed outside the scan driver 120 in the first direction DR1 with the display unit 110 and the scan driver 120 disposed therebetween, without limitation thereto.

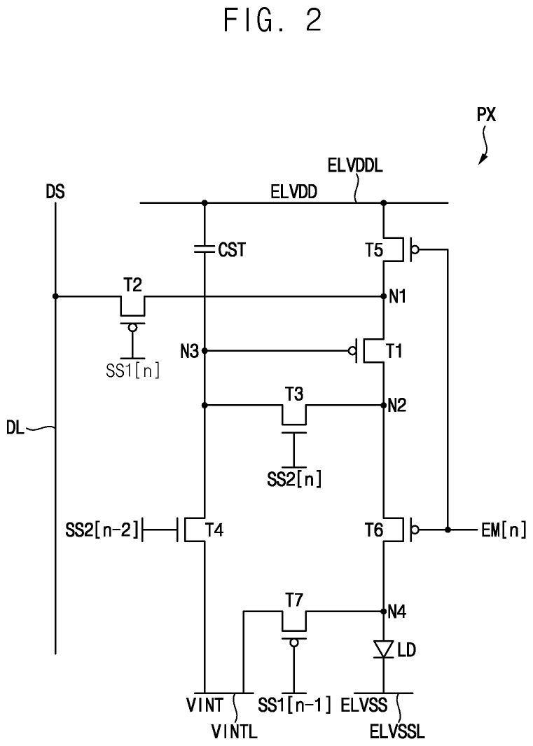

FIG. 2 illustrates a pixel PX according to an embodiment. For example, FIG. 2 may illustrate a pixel PX of the n^{th} pixel row PR[n] in FIG. 1, without limitation thereto.

Referring to FIG. 2, the pixel PX may include a plurality of transistors, at least one capacitor, and a light-emitting diode LD. In an embodiment, the plurality of transistors may include a first transistor T1, a second transistor T2, a third transistor T3, a fourth transistor T4, a fifth transistor T5, a sixth transistor T6, and a seventh transistor T7, and the at least one capacitor may include a storage capacitor CST.

The first transistor T1 may be connected between a first node N1 and a second node N2, and may be turned on in response to a voltage of a third node N3. A first electrode (e.g., a source electrode) of the first transistor T1 may be connected to the first node N1, and a second electrode (e.g., a drain electrode) of the first transistor T1 may be connected to the second node N2. A gate electrode of the first transistor T1 may be connected to the third node N3. The first transistor T1 may generate a driving current based on a voltage between the third node N3 and the first node N1. The first transistor T1 may be referred to as a driving transistor.

The second transistor T2 may be connected between a data line DL carrying the data signal DS and the first node N1, and may be turned on in response to an n^{th} first scan signal SS1[n]. The n^{th} first scan signal SS1[n] may be a first scan signal SS1 output from an n^{th} stage of the scan driver 120. A first electrode (e.g., a source electrode) of the second transistor T2 may be connected to the data line DL, and a second electrode (e.g., a drain electrode) of the second transistor T2 may be connected to the first node N1. A gate electrode of the second transistor T2 may be connected to an n^{th} first scan line carrying the n^{th} first scan signal SS1[n]. The second transistor T2 may write the data signal DS to the first node N1 in response to the n^{th} first scan signal SS1[n]. The second transistor T2 may be referred to as a write transistor.

The third transistor T3 may be connected between the second node N2 and the third node N3, and may be turned on in response to an n^{th} second scan signal SS2[n]. The n^{th} second scan signal SS2[n] may be a second scan signal SS2 output from the n^{th} stage of the scan driver 120. A first electrode (e.g., a drain electrode) of the third transistor T3 may be connected to the second node N2, and a second electrode (e.g., a source electrode) of the third transistor T3 may be connected to the third node N3. A gate electrode of the third transistor T3 may be connected to an n^{th} second scan line carrying the n^{th} second scan signal SS2 [n]. The third transistor T3 may electrically connect the second electrode of the first transistor T1 and the gate electrode of the first transistor T1 in response to the n^{th} second scan signal SS2[n]. The third transistor T3 may be referred to as a compensation transistor.

The fourth transistor T4 may be connected between an initialization line VINTL carrying an initialization voltage VINT and the third node N3, and may be turned on in response to an (n−2)^{th} second scan signal SS2[n−2]. The (n−2)^{th} second scan signal SS2[n−2] may be a second scan signal SS2 output from an (n−2)^{th} stage of the scan driver 120. A first electrode (e.g., a drain electrode) of the fourth transistor T4 may be connected to the initialization line VINTL, and a second electrode (e.g., a source electrode) of the fourth transistor T4 may be connected to the third node N3. A gate electrode of the fourth transistor T4 may be connected to an (n−2)^{th} second scan line carrying the (n−2)^{th} second scan signal SS2[n−2]. The fourth transistor T4 may initialize the third node N3 with the initialization voltage VINT in response to the (n−2)^{th} second scan signal SS2[n−2]. The fourth transistor T4 may be referred to as a driving initialization transistor.

The fifth transistor T5 may be connected between a first power line ELVDDL carrying a first power voltage ELVDD and the first node N1, and turned on in response to an n^{th} emission signal EM[n]. The n^{th} emission signal EM[n] may be an emission signal EM output from an n^{th} stage of the emission driver 140. A first electrode (e.g., a source electrode) of the fifth transistor T5 may be connected to the first power line ELVDDL, and a second electrode (e.g., a drain electrode) of the fifth transistor T5 may be connected to the first node N1. A gate electrode of the fifth transistor T5 may be connected to an n^{th} emission line carrying the n^{th} emission signal EM[n]. The fifth transistor T5 may electrically connect the first power line ELVDDL and the first node N1 in response to the n^{th} emission signal EM[n].

The sixth transistor T6 may be connected between the second node N2 and a fourth node N4, and may be turned on in response to the n^{th} emission signal EM[n]. A first electrode (e.g., a source electrode) of the sixth transistor T6 may be connected to the second node N2, and a second electrode (e.g., a drain electrode) of the sixth transistor T6 may be connected to the fourth node N4. A gate electrode of the sixth transistor T6 may be connected to the n^{th} emission line. The sixth transistor T6 may electrically connect the second node N2 and the fourth node N4 in response to the n^{th} emission signal EM[n]. Each of the fifth transistor T5 and the sixth transistor T6 may be referred to as an emission control transistor.

The seventh transistor T7 may be connected between the initialization line VINTL and the fourth node N4, and may be turned on in response to an (n−1)^{th} first scan signal SS1[n−1]. The (n−1)^{th} first scan signal SS1[n−1] may be a first scan signal SS1 output from an (n−1)^{th} stage of the scan driver 120. A first electrode (e.g., a source electrode) of the seventh transistor T7 may be connected to the initialization line VINTL, and a second electrode (e.g., a drain electrode) of the seventh transistor T7 may be connected to the fourth node N4. A gate electrode of the seventh transistor T7 may be connected to an (n−1)^{th} first scan line carrying the (n−1)^{th} first scan signal SS1[n−1]. The seventh transistor T7 may initialize the fourth node N4 with the initialization voltage VINT in response to the (n−1)^{th} first scan signal SS1[n−1]. The seventh transistor T7 may be referred to as a diode initialization transistor.

In an embodiment, each of the first transistor T1, the second transistor T2, the fifth transistor T5, the sixth transistor T6, and the seventh transistor T7 may be a P-type transistor (e.g., a PMOS transistor), and each of the third transistor T3 and the fourth transistor T4 may be an N-type transistor (e.g., an NMOS transistor). In such an embodiment, a turn-on voltage of each of the first transistor T1, the second transistor T2, the fifth transistor T5, the sixth transistor T6, and the seventh transistor T7 may be a low voltage, and a turn-on voltage of each of the third transistor T3 and the fourth transistor T4 may be a high voltage.

Although NMOS transistors may be faster than PMOS transistors due to greater electron mobility or the like, there may also be exceptions. For example, a time required for an N-type transistor including an oxide semiconductor to be turned on may be greater than a time required for a P-type transistor including a polycrystalline silicon semiconductor to be turned on. Accordingly, a time during which second scan signals SS2[n] and SS2[n−2] respectively applied to the third transistor T3 and the fourth transistor T4, which are N-type transistors, maintain turn-on voltages may be greater than a time during which first scan signals SS1[n] and SS1[n−1] respectively applied to the second transistor T2 and the seventh transistor T7, which are P-type transistors, maintain turn-on voltages.

The storage capacitor CST may be connected between the first power line ELVDDL and the third node N3. A first electrode of the storage capacitor CST may be connected to the third node N3, and a second electrode of the storage capacitor CST may be connected to the first power line ELVDDL. The storage capacitor CST may store the voltage of the third node N3.

The light-emitting diode LD may be connected between the fourth node N4 and a second power line ELVSSL carrying a second power voltage ELVSS. A first electrode (e.g., an anode) of the light-emitting diode LD may be connected to the fourth node N4, and a second electrode (e.g., a cathode) of the light-emitting diode LD may be connected to the second power line ELVSSL. The light-emitting diode LD may emit light based on the driving current. For example, the light-emitting diode LD may emit light having a luminance corresponding to the driving current.

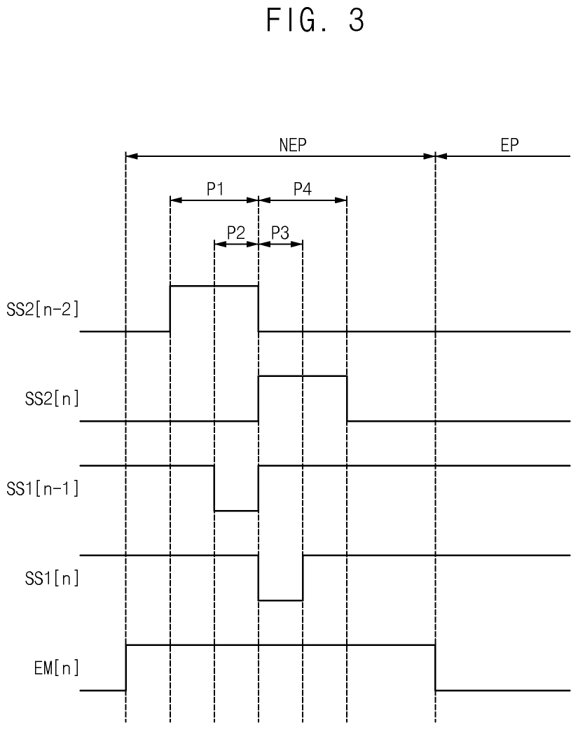

FIG. 3 illustrates signals for describing an operation of the pixel PX in FIG. 2 during one frame period, without limitation thereto.

Referring to FIG. 3, a frame period may include a non-emission period NEP and an emission period EP. In the non-emission period NEP, the fifth transistor T5 and the sixth transistor T6 may be turned off in response to a high voltage of the n^{th} emission signal EM[n], and the first transistor T1 and the light-emitting diode LD may be electrically separated. Accordingly, in the non-emission period NEP, the driving current need not flow through the light-emitting diode LD, and the light-emitting diode LD need not emit light. The non-emission period NEP may include a first period P1, a second period P2, a third period P3, and a fourth period P4, without limitation thereto.

In the first period P1, the fourth transistor T4 may be turned on in response to a high voltage of the (n−2)^{th} second scan signal SS2[n−2], and the initialization voltage VINT may be applied to the third node N3. Accordingly, in the first period P1, the gate electrode of the first transistor T1 may be initialized by the initialization voltage VINT.

In the second period P2, the seventh transistor T7 may be turned on in response to a low voltage of the (n−1)^{th} first scan signal SS1[n−1], and the initialization voltage VINT may be applied to the fourth node N4. Accordingly, in the second period P2, the first electrode of the light-emitting diode LD may be initialized by the initialization voltage VINT.

In the third period P3, the third transistor T3 may be turned on in response to a high voltage of the n^{th} second scan signal SS2[n], and the first transistor T1 may be diode-connected. Further, in the third period P3, the second transistor T2 may be turned on in response to a low voltage of the n^{th} first scan signal SS1[n], and the data signal DS in which a threshold voltage of the first transistor T1 is compensated may be applied to the third node N3. Accordingly, in the third period P3, the data signal DS in which the threshold voltage of the first transistor T1 is compensated may be written in the storage capacitor CST.

In the fourth period P4, the third transistor T3, which as an N-type may take more time to turn on than the second transistor T2 which may be a P-type, may remain turned on in response to the high voltage of the n^{th} second scan signal SS2[n], and the first transistor T1 may remain diode-connected. Further, in the fourth period P4, the second transistor T2 may be turned off in response to a high voltage of the n^{th} first scan signal SS1[n], and the data signal DS in which a threshold voltage of the first transistor T1 is compensated need not be applied to the third node N3.

In the emission period EP, the fifth transistor T5 and the sixth transistor T6 may be turned on in response to a low voltage of the n^{th} emission signal EM[n], and the first transistor T1 and the light-emitting diode LD may be electrically connected. Accordingly, in the emission period EP, the driving current may flow through the light-emitting diode LD, and the light-emitting diode LD may emit light based on the driving current.

In an embodiment, the phasing between the first scan signals SS1 and the second scan signals SS2 is not limited to that shown for illustrative purposes in FIG. 3. For example the first period P1 may be shifted to start before and/or end after the second period P2; and the fourth period P4 may be shifted to start before and/or end after the third period P3.

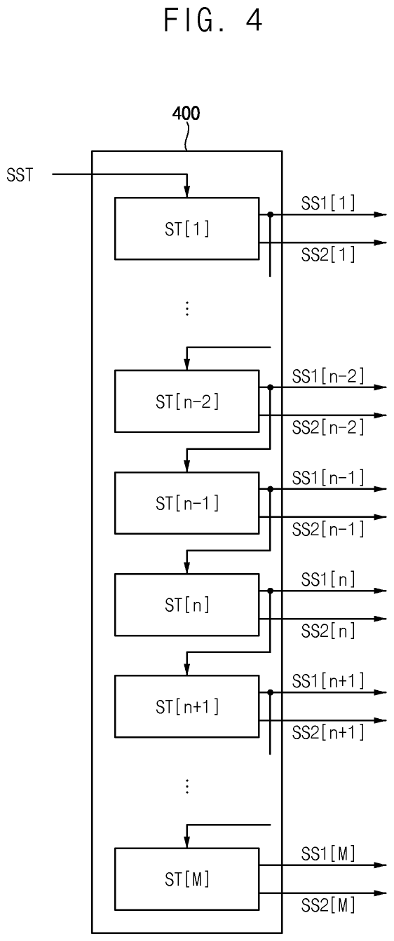

FIG. 4 illustrates a scan driver 400 according to an embodiment.

Referring to FIG. 4, a scan driver 400 may include a plurality of stages ST[1], ST[n−2], ST[n−1], ST[n], ST[n+1], ST[M]. The second control signal SCS provided to the scan driver 400 may include the scan start signal SST, and the scan start signal SST may be input to the first stage ST[1]. The first scan signal SS1 output from the previous stage may be input to each of the second to M^{th} stages ST[2], ST[n−2], ST[n−1], ST[n], ST[n+1], ST[M]. Each of the stages ST[1], ST[n−2], ST[n−1], ST[n], ST[n+1], ST[M] may output the first scan signal SS1 and the second scan signal SS2.

For example, the first stage ST[1] may output a 1st first scan signal SS1[1] and a 1^{st} second scan signal SS2[1] based on the scan start signal SST. The (n−1)^{th} stage ST[n−1] may output an (n−1)^{th} first scan signal SS1[n−1] and an (n−1)^{th} second scan signal SS2[n−1] based on an (n−2)^{th} first scan signal SS1[n−2]. The n^{th} stage ST[n] may output an n^{th} first scan signal SS1[n] and an n^{th} second scan signal SS2[n] based on the (n−1)^{th} first scan signal SS1[n−1]. The (n+1)^{th} stage ST[n+1] may output an (n+1)^{th} first scan signal SS1[n+1] and an (n+1)^{th} second scan signal SS2[n+1] based on the n^{th} first scan signal SS1[n]. The M^{th} stage ST[M] may output an M^{th} first scan signal SS1[M] and an M^{th} second scan signal SS2[M] based on an (M−1)^{th} first scan signal SS1[M−1].

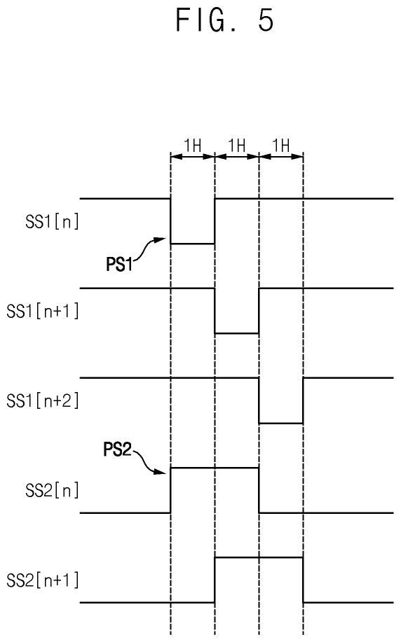

FIG. 5 illustrates scan signals output from the scan driver 400 of FIG. 4. For convenience of description, FIG. 5 illustrates the n^{th} first scan signal SS1[n], the (n+1)^{th} first scan signal SS1[n+1], the (n+2)^{th} first scan signal SS1[n+2], the n^{th} second scan signal SS2[n], and the (n+1)^{th} second scan signal SS2[n+1] among the scan signals output from the scan driver 400, without limitation thereto.

Referring to FIG. 5, the first scan signal SS1 may include a first pulse PS1. The first scan signal SS1 may have a high voltage in a period other than a period in which the first pulse PS1 is generated, and may have a low voltage in the period in which the first pulse PS1 is generated. The high voltage of the first scan signal SS1 may be a voltage at which the P-type transistor is turned off, and the low voltage of the first scan signal SS1 may be a voltage at which the P-type transistor is turned on. In an embodiment, a width of the first pulse PS1 may be less than or substantially equal to 1 horizontal time 1H.

The (n+1)^{th} first scan signal SS1[n+1] may be a signal obtained by shifting the n^{th} first scan signal SS1[n] by 1 horizontal time 1H. The n^{th} first scan signal SS1[n] and the (n+1)^{th} first scan signal SS1[n+1] need not overlap. Further, the (n+2)^{th} first scan signal SS1[n+2] may be a signal obtained by shifting the (n+1)^{th} first scan signal SS1[n+1] by 1 horizontal time 1H. The (n+1)^{th} first scan signal SS1[n+1] and the (n+2)^{th} first scan signal SS1[n+2] need not overlap.

The second scan signal SS2 may be obtained based on inverting the first scan signal SS1, without limitation thereto, and may include a second pulse PS2. The second scan signal SS2 may have a low voltage in a period other than a period in which the second pulse PS2 is generated, and may have a high voltage in the period in which the second pulse PS2 is generated. The low voltage of the second scan signal SS2 may be a voltage at which the N-type transistor is turned off, and the high voltage of the second scan signal SS2 may be a voltage at which the N-type transistor is turned on. The low voltage of the second scan signal SS2 may be substantially equal to the low voltage of the first scan signal SS1, and the high voltage of the second scan signal SS2 may be substantially equal to the high voltage of the first scan signal SS1.

A width of the second pulse PS2 may be greater than the width of the first pulse PS1. The width of the second pulse PS2 may be twice or more than the width of the first pulse PS1. In an embodiment, the width of the second pulse PS2 may be twice or more than the width of the first pulse PS1 and less than or equal to 2 horizontal times 2H.

The first scan signal SS1 may be applied to the P-type transistors (e.g., the second transistor T2 and the seventh transistor T7 of the pixel PX), and the second scan signal SS2 may be applied to the N-type transistors (e.g., the third transistor T3 and the fourth transistor T4 of the pixel PX), and the time required for the N-type transistor including an oxide semiconductor to be turned on may be greater than the time required for the P-type transistor including a polycrystalline silicon semiconductor to be turned on. Accordingly, the width of the second pulse PS2 of the second scan signal SS2 may be greater than the width of the first pulse PS1 of the first scan signal SS1.

The (n+1)^{th} second scan signal SS2[n+1] may be a signal obtained by shifting the n^{th} second scan signal SS2[n] by 1 horizontal time 1H. The n^{th} second scan signal SS2[n] and the (n+1)^{th} second scan signal SS2[n+1] may partially overlap.

A display device according to a comparative example of the prior art may include a first scan driver including stages respectively outputting first scan signals SS1 for driving a P-type transistor and a second scan driver including stages respectively outputting second scan signals SS2 for driving an N-type transistor. In the prior art, the display device may include a plurality of scan drivers, so that an area of the scan drivers may increase, and a dead space of the display device may increase. However, the scan driver 400 according to the embodiment of the present disclosure may include the stages ST[1], ST[n−2], ST[n−1], ST[n], ST[n+1], ST[M] each outputting the first scan signal SS1 and the second scan signal SS2, so that an area of the scan driver 400 may be reduced, and a dead space of the display device 100 may be reduced.

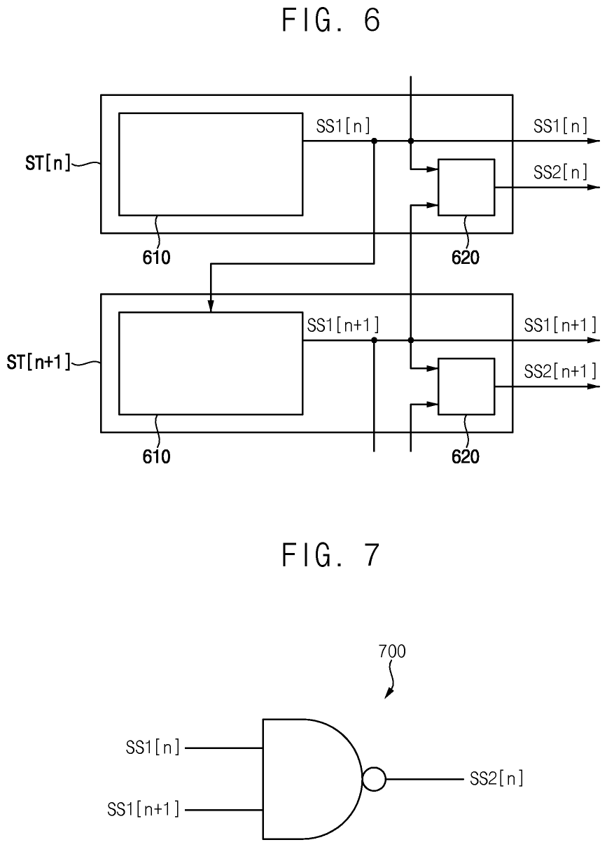

FIG. 6 illustrates stages according to an embodiment. FIG. 6 may illustrate the n^{th} stage ST[n] and the (n+1)^{th} stage ST[n+1] of the scan driver 400 in FIG. 4, without limitation thereto.

Referring to FIG. 6, each of the stages ST[n] and ST[n+1] may include a scan signal generator 610 and a scan signal converter 620.

The scan signal generator 610 may generate the first scan signal SS1. The scan signal generator 610 of the n^{th} stage ST[n] may generate the n^{th} first scan signal SS1[n] based on the (n−1)^{th} first scan signal SS1[n−1], and the scan signal generator 610 of the (n+1)^{th} stage ST[n+1] may generate the (n+1)^{th} first scan signal SS1[n+1] based on the n^{th} first scan signal SS1[n].

In an embodiment, the scan signal generator 610 may include at least one P-type transistor (e.g., a PMOS transistor) and at least one N-type transistor (e.g., a NMOS transistor). However, the present disclosure is not limited thereto, and in another embodiment, the scan signal generator 610 may include only P-type transistors or only N-type transistors.

The scan signal converter 620 may generate the second scan signal SS2 based on the first scan signal SS1. The scan signal converter 620 of the n^{th} stage ST[n] may generate the n^{th} second scan signal SS2[n] based on the n^{th} first scan signal SS1[n] and the (n+1)^{th} first scan signal SS1[n+1], and the scan signal converter 620 of the (n+1)^{th} stage ST[n+1] may generate the (n+1)^{th} second scan signal SS2[n+1] based on the (n+1)^{th} first scan signal SS1[n+1] and the (n+2)^{th} first scan signal SS1[n+2].

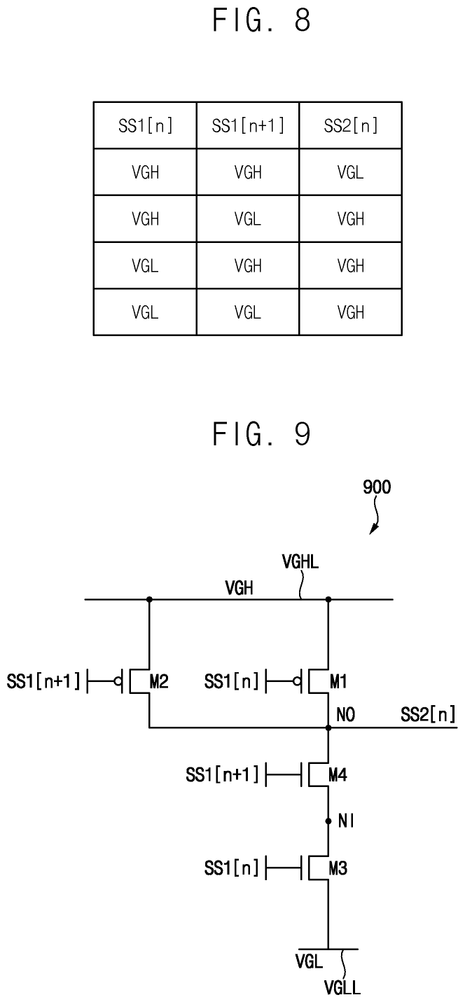

FIG. 7 illustrates a scan signal converter 700 according to an embodiment. For example, FIG. 7 may illustrate the scan signal converter 620 of the n^{th} stage ST[n] in FIG. 6, without limitation thereto. FIG. 8 illustrates inputs and an output of the scan signal converter 700 in FIG. 7.

Referring to FIGS. 7 and 8, in an embodiment, the scan signal converter 700 may be implemented as a NAND gate having two inputs and one output. The scan signal converter 700 may receive the n^{th} first scan signal SS1[n] and the (n+1)^{th} first scan signal SS1[n+1], and may output the n^{th} second scan signal SS2[n]. The delay for this operation may be shifted relative to 1H to suit design criteria for the phasing of SS2 versus SS1.

When the n^{th} first scan signal SS1[n] and the (n+1)^{th} first scan signal SS1[n+1] have the high voltage VGH, the n^{th} second scan signal SS2[n] having the low voltage VGL may be output. When at least one of the n^{th} first scan signal SS1[n] and the (n+1)^{th} first scan signal SS1[n+1] has the low voltage VGL, the n^{th} second scan signal SS2 [n] having the high voltage VGH may be output.

FIG. 9 illustrates a scan signal converter 900 according to an embodiment. For example, FIG. 9 may illustrate the scan signal converter 620 of the n^{th} stage ST[n] in FIG. 6, without limitation thereto.

Referring to FIG. 9, a scan signal converter 900 may include a plurality of transistors. The plurality of transistors may include a first transistor M1, a second transistor M2, a third transistor M3, and a fourth transistor M4.

The first transistor M1 may be connected between a high voltage line VGHL carrying the high voltage VGH and an output node NO at which the n^{th} second scan signal SS2[n] is output, and may be turned on in response to the n^{th} first scan signal SS1[n] having a low voltage. A first electrode (e.g., a source electrode) of the first transistor M1 may be connected to the high voltage line VGHL, and a second electrode (e.g., a drain electrode) of the first transistor M1 may be connected to the output node NO. A gate electrode of the first transistor M1 may be connected to an n^{th} first scan line carrying the n^{th} first scan signal SS1[n]. The first transistor M1 may electrically connect the high voltage line VGHL and the output node NO in response to the n^{th} first scan signal SS1[n].

The second transistor M2 may be connected between the high voltage line VGHL and the output node NO, and may be turned on in response to the (n+1)^{th} first scan signal SS1[n+1] having a low voltage. A first electrode (e.g., a source electrode) of the second transistor M2 may be connected to the high voltage line VGHL, and a second electrode (e.g., a drain electrode) of the second transistor M2 may be connected to the output node NO. Accordingly, the second transistor M2 may be connected in parallel with the first transistor M1. A gate electrode of the second transistor M2 may be connected to an (n+1)^{th} first scan line carrying the (n+1)^{th} first scan signal SS1[n+1]. The second transistor M2 may electrically connect the high voltage line VGHL and the output node NO in response to the (n+1)^{th} first scan signal SS1[n+1].

The third transistor M3 may be connected between a low voltage line VGLL carrying the low voltage VGL and an intermediate node NI, and may be turned off in response to the n^{th} first scan signal SS1[n] having a low voltage. A first electrode (e.g., a drain electrode) of the third transistor M3 may be connected to the low voltage line VGLL, and a second electrode (e.g., a source electrode) of the third transistor M3 may be connected to the intermediate node NI. A gate electrode of the third transistor M3 may be connected to the n^{th} first scan line. The third transistor M3 may electrically separate the low voltage line VGLL and the intermediate node NI in response to the n^{th} first scan signal SS1[n].

The fourth transistor M4 may be connected between the intermediate node NI and the output node NO, and may be turned off in response to the (n+1)^{th} first scan signal SS1[n+1] having a low voltage. A first electrode (e.g., a drain electrode) of the fourth transistor M4 may be connected to the intermediate node NI, and a second electrode (e.g., a source electrode) of the fourth transistor M4 may be connected to the output node NO. Accordingly, the fourth transistor M4 may be connected in series to the third transistor M3. A gate electrode of the fourth transistor M4 may be connected to the (n+1)^{th} first scan line. The fourth transistor M4 may electrically separate the intermediate node NI from the output node NO in response to the (n+1)^{th} first scan signal SS1[n+1].

In an embodiment, each of the first transistor M1 and the second transistor M2 may be a P-type transistor (e.g., a PMOS transistor), and each of the third transistor M3 and the fourth transistor M4 may be an N-type transistor (e.g., an NMOS transistor). In such an embodiment, a turn-on voltage of each of the first transistor M1 and the second transistor M2 may be the low voltage VGL, and a turn-on voltage of each of the third transistor M3 and the fourth transistor M4 may be the high voltage VGH.

When the n^{th} first scan signal SS1[n] has the low voltage VGL, the first transistor M1 may be turned on and the third transistor M3 may be turned off, so that the high voltage VGH may be applied the output node NO. When the (n+1)^{th} first scan signal SS1[n+1] has the low voltage VGL, the second transistor M2 may be turned on and the fourth transistor M4 may be turned off, so that the high voltage VGH may be applied to the output node NO. When the n^{th} first scan signal SS1[n] and the (n+1)^{th} first scan signal SS1[n+1] have the low voltage, the first transistor M1 may be turned on and the third transistor M3 may be turned off, and the second transistor M2 may be turned on and the fourth transistor M4 may be turned off, so that the high voltage VGH may be applied to the output node NO. When the n^{th} first scan signal SS1[n] and the (n+1)^{th} first scan signal SS1[n+1] have the high voltage VGH, the first and second transistors M1 and M2 may be turned off and the third and fourth transistors M3 and M4 may be turned on, so that the low voltage VGL may be applied to the output node NO.

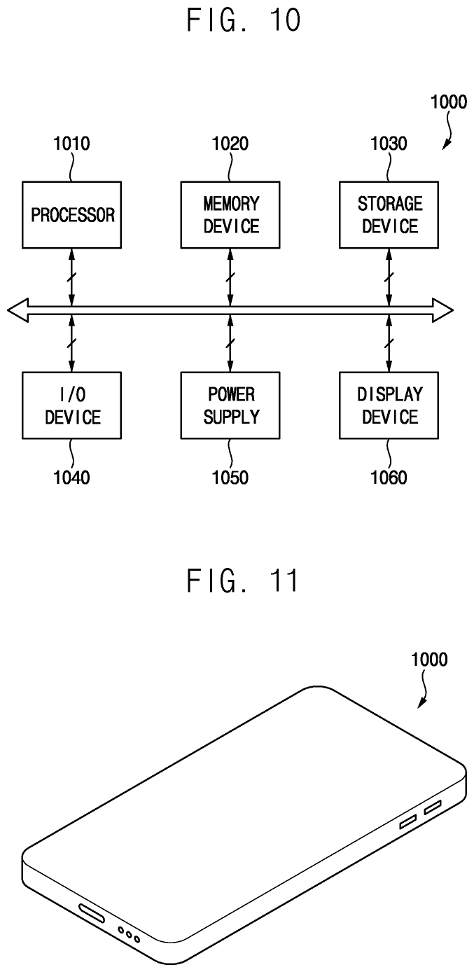

FIG. 10 illustrates an electronic apparatus 1000 including a display device 1060 according to an embodiment. FIG. 11 illustrates an example of the electronic apparatus 1000 in FIG. 10, without limitation thereto.

Referring to FIGS. 10 and 11, an electronic apparatus 1000 may include a processor 1010, a memory device 1020, a storage device 1030, an input/output (“I/O”) device 1040, a power supply 1050, and a display device 1060. The display device 1060 may be the display device 100 of FIG. 1. The electronic apparatus 1000 may further include a plurality of ports for communicating with a video card, a sound card, a memory card, a universal serial bus (“USB”) device, or the like.

In an embodiment, as illustrated in FIG. 11, the electronic apparatus 1000 may be implemented as a smart phone. However, the present disclosure is not limited thereto, and the electronic apparatus 1000 may be implemented as a mobile phone, a video phone, a smart pad, a smart watch, a tablet PC, a vehicle navigation system, a computer monitor, a laptop computer, a head mounted display, or the like.

The processor 1010 may perform particular calculations or tasks. In an embodiment, the processor 1010 may be a microprocessor, a central processing unit (“CPU”), or the like. The processor 1010 may be coupled to other components via an address bus, a control bus, a data bus, or the like. In an embodiment, the processor 1010 may be coupled to an extended bus such as a peripheral component interconnection (“PCI”) bus.

The memory device 1020 may store data for operations of the electronic apparatus 1000. In an embodiment, the memory device 1020 may include a non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, or the like, and/or a volatile memory device such as a dynamic random access memory (“DRAM”) device, a static random access memory (“SRAM”) device, a mobile DRAM device, or the like.

The storage device 1030 may include a solid state drive (“SSD”) device, a hard disk drive (“HDD”) device, a CD-ROM device, or the like. The I/O device 1040 may include an input device such as a keyboard, a keypad, a touchpad, a touch-screen, a mouse device, or the like, and an output device such as a speaker, a printer, or the like. The power supply 1050 may supply a power required for the operation of the electronic apparatus 1000. The display device 1060 may be coupled to other components via the buses or other communication links.

In the display device 1060, each of stages of a scan driver included in the display device 1060 may output a first scan signal for driving a P-type transistor and a second scan signal for driving an N-type transistor, so that an area of the scan driver may be reduced, and a dead space of the display device 1060 may be reduced. Although an embodiment having both P-type transistors with relatively faster turn-on and N-type transistors with relatively slower turn-on was illustrated and described, the present disclosure is not limited thereto. For example, an embodiment with faster turn-on N-type transistors and slower turn-on P-type transistors may be implemented by inverting SS2 and SS1. For another example, an embodiment with all P-type transistors or all N-type transistors may be implemented by adding delay inverters and/or inverting one but not both of SS2 and SS1.

The display device according to these and other embodiments may be applied to a display device included in an electronic apparatus such as a computer, a notebook, a mobile phone, a smart phone, a smart pad, a PMP, a PDA, an MP3 player, or the like, without limitation thereto.

Although scan drivers and display devices according to illustrative embodiments have been described with reference to the drawings, the illustrated embodiments are examples, and may be modified and changed by a person having ordinary knowledge or skill in the relevant technical field or pertinent art without departing from the scope or technical spirit of the present disclosure as set forth in the following claims.

What is claimed is:

1. A scan driver, comprising:
a plurality of stages connected to pixel rows,
wherein each of the stages outputs a first scan signal including a first pulse, and a second scan signal including a second pulse having a width greater than a width of the first pulse.

2. The scan driver of claim 1, wherein each of the stages includes:
a scan signal generator which generates the first scan signal; and
a scan signal converter which generates the second scan signal based on the first scan signal.

3. The scan driver of claim 2, wherein the scan signal converter is implemented as a NAND gate.

4. The scan driver of claim 2,
wherein the stages include an n^{th} stage and an (n+1)^{th} stage where n is a natural number greater than or equal to 1, and
wherein the scan signal converter of the n^{th} stage generates an n^{th} second scan signal based on an n^{th} first scan signal generated from the scan signal generator of the n^{th} stage and an (n+1)^{th} first scan signal generated from the scan signal generator of the (n+1)^{th} stage.

5. The scan driver of claim 4, wherein the scan signal converter of the n^{th} stage includes:
a first transistor connected between a high voltage line carrying a high voltage and an output node outputting the n^{th} second scan signal, and turned on in response to the n^{th} first scan signal;
a second transistor connected between the high voltage line and the output node, and turned on in response to the (n+1)^{th} first scan signal;
a third transistor connected between a low voltage line carrying a low voltage and an intermediate node, and turned off in response to the n^{th} first scan signal; and
a fourth transistor connected between the intermediate node and the output node, and turned off in response to the (n+1)^{th} first scan signal.

6. The scan driver of claim 5,
wherein each of the first transistor and the second transistor is a P-type transistor, and
wherein each of the third transistor and the fourth transistor is an N-type transistor.

7. The scan driver of claim 4, wherein an (n+1)^{th} second scan signal output from the (n+1)^{th} stage partially overlaps the n^{th} second scan signal output from the n^{th} stage.

8. The scan driver of claim 2, wherein the scan signal generator includes a P-type transistor and an N-type transistor.

9. The scan driver of claim 1,
wherein the second scan signal is obtained based on inverting the first scan signal,
wherein the width of the second pulse is twice or more than the width of the first pulse.

10. A display device, comprising:
pixel rows each of which includes a plurality of pixels; and
a scan driver which includes a plurality of stages connected to the pixel rows,
wherein each of the stages outputs a first scan signal including a first pulse, and a second scan signal including a second pulse having a width greater than a width of the first pulse.

11. The display device of claim 10, wherein each of the stages includes:
a scan signal generator which generates the first scan signal; and
a scan signal converter which generates the second scan signal based on the first scan signal.

12. The display device of claim 11, wherein the scan signal converter is implemented as a NAND gate.

13. The display device of claim 11, wherein the stages include an n^{th} stage and an (n+1)^{th} stage where n is a natural number greater than or equal to 1, and
wherein the scan signal converter of the n^{th} stage generates an n^{th} second scan signal based on an n^{th} first scan signal generated from the scan signal generator of the n^{th} stage and an (n+1)^{th} first scan signal generated from the scan signal generator of the (n+1)^{th} stage.

14. The display device of claim 13, wherein an (n+1)^{th} second scan signal output from the (n+1)^{th} stage partially overlaps the n^{th} second scan signal output from the n^{th} stage.

15. The display device of claim 10,
wherein the second scan signal is obtained based on inverting the first scan signal,
wherein the width of the second pulse is twice or more than the width of the first pulse.

16. The display device of claim 10, wherein each of the pixels includes:
a P-type transistor turned on in response to the first scan signal; and
an N-type transistor turned on in response to the second signal.

17. The display device of claim 10, further comprising:
an emission driver which outputs emission signals to the pixel rows, respectively.

18. The display device of claim 17, wherein the pixel rows include an n^{th} pixel row where n is a natural number greater than or equal to 3,
wherein the stages include an (n−2)^{th} stage outputting an (n−2)^{th} first scan signal and an (n−2)^{th} second scan signal, an (n−1)^{th} stage outputting an (n−1)^{th} first scan signal and an (n−1)^{th} second scan signal, and an n^{th} stage outputting an n^{th} first scan signal and an n^{th} second scan signal,
wherein the emission signals include an n^{th} emission signal, and
wherein a pixel of the n^{th} pixel row receives the n^{th} first scan signal, the n^{th} second scan signal, the (n−2)^{th} second scan signal, the n^{th} emission signal, and the (n−1)^{th} first scan signal.

19. The display device of claim 18, wherein the pixel of the n^{th} pixel row includes:
a first transistor connected between a first node and a second node, and turned on in response to a voltage of a third node;
a second transistor connected between a data line carrying a data signal and the first node, and turned on in response to the n^{th} first scan signal;
a third transistor connected between the second node and the third node, and turned on in response to the n^{th} second scan signal;
a fourth transistor connected between an initialization line carrying an initialization voltage and the third node, and turned on in response to the (n−2)^{th} second scan signal;
a fifth transistor connected between a first power line carrying a first power voltage and the first node, and turned on in response to the n^{th} emission signal;
a sixth transistor connected between the second node and a fourth node, and turned on in response to the n^{th} emission signal;
a seventh transistor connected between the initialization line and the fourth node, and turned on in response to the (n−1)^{th} first scan signal;
a storage capacitor connected between the first power line and the third node; and
a light-emitting diode connected between the fourth node and a second power line carrying a second power voltage.

20. The display device of claim 19, wherein each of the first transistor, the second transistor, the fifth transistor, the sixth transistor, and the seventh transistor is a P-type transistor, and
wherein each of the third transistor and the fourth transistor is an N-type transistor.
